(19) United States
(12) Patent Application Publication
(10) Pub. No.: US 2004/0108983 A1
(43) Pub. Date: Jun. 10, 2004

(54) LED display and method for driving the same

(76) Inventors: Chien-Fu Tseng, Yunlin County (TW); Cheng-Nan Yeh, Taoyuan City (TW)

Correspondence Address: BIRCH STEWART KOLASCH & BIRCH, PO BOX 747, FALLS CHURCH, VA, 22040-0747, US

(21) Appl. No.: 10/683,440

(22) Filed: Oct. 14, 2003

(30) Foreign Application Priority Data
Dec. 9, 2002 (TW) 91135535

(51) Int. Cl. G09G 3/32; G09G 5/00

(52) U.S. Cl. 345/82

(57) ABSTRACT

A method for driving an LED display. The LED display has an array composed of rows and columns of pixels, wherein each of the pixels comprises an LED. The method comprises the steps of generating a plurality of scan signals, each of which is fed to a corresponding row, wherein one of the rows is selected when a pulse occurs in the corresponding scan signal, generating a plurality of data signals, each of which turns on or off the LED of one of the pixels in the selected row of the array, and adjusting a width of the pulse in the scan signal fed to the selected row according to the number of turned-on pixels in the selected row.

### BACKGROUND OF THE INVENTION

1. Field of the Invention

The present invention relates to an LED display and particularly to a PLED or OLED display having scan signals pulse widths that vary according to the number of turned-on LEDs, which achieves uniform luminance in displayed images.

2. Description of the Prior Art

PLEDs (Polymer Light Emitting Diodes) and OLEDs (Organic Light Emitting Diodes) are self-emitting elements. PLED or OLED displays do not require a backlight system as used in LCDs (Liquid Crystal Displays) so cost and power consumption are much lower than LCDs. With the intrinsic power limitation of a battery, PLED or OLED displays will eventually replace the LCDs popularly used in portable devices due to their low cost and low power consumption. Besides, the PLED or OLED display is thinner than the LCD and easily applied on various substrate materials, such as plastic. With the PLED or OLED display, a “rollable” calculator may be available in the future. Accordingly, many researchers around the world have concentrated their effort on improving PLED and OLED displays.

FIG. 1 shows a conventional PLED or OLED display. It includes an array 11, a row driver 12 and a column driver 13. The array 11 is composed of rows and columns of pixels 14. Each of the pixels 14 has an LED (PLED or OLED) 141 with the cathode coupled to one of the scan lines R0-R4 and the anode coupled to one of the data lines C0˜C4. For illustration, the array 11 shown in FIG. 1 has a size of only 5*5. In practice, the size of the array 11 is typically much larger than 5*5.

The operation of the PLED or OLED display will be described in the following with reference to FIG. 2 showing a timing diagram of the display. The row driver 12 generates a scan signal on each of the scan lines R0˜R4. There are negative pulses occurring periodically in each of the scan signals. When any of the negative pulses occurs on one of the scan lines R0˜R4, the row connected thereto is selected, wherein the voltage level on the cathodes of the LEDs 141 in the selected row is pulled down. If a relatively high voltage level is generated by the column driver 13 on the data line connected to the LEDs 141 in the selected row, these LEDs 141 are turned on. The other un-selected rows of the LEDs 141 are turned off even if the high voltage level is generated on the data lines connected thereto. This is because the voltage across the LEDs 141 are not large enough due to the voltage level on their cathodes not being pulled down by the scan signals. As the row driver 12 sequentially generates pulses on the scan lines R0˜R4, the rows of the array 11 are selected one by one, and the column driver 13 generates the high and low voltage levels on the data lines C0˜C1 according to the pixel data to turn on or off the LEDs 141 in the selected row, which form frames of images.

However, the driving currents provided by the column driver 13 and flowing through the LEDs 141 vary with the number of turned-on LEDs 141 in the selected row, which results in non-uniform luminance of the image. For example, If there are three turned-on LEDs in the row R0 and one turned-on LED in the row R1, the luminance of each of the LEDs in the row R1 is weaker than that of the LEDs in the row R0 since the column driver 13 drives three LEDs in the row R0 but only one LED in the row R1. Thus, the luminance of each row in the array 11 is different.

### SUMMARY OF THE INVENTION

The object of the present invention is to provide an LED display and method for driving the same, which achieves frames of images with uniform luminance.

The present invention provides a method for driving an LED display. The LED display has an array composed of rows and columns of pixels, wherein each of the pixels comprises an LED. The method comprises the steps of generating a plurality of scan signals, each of which is fed to a corresponding row, wherein one of the rows is selected when a pulse occurs in the corresponding scan signal, generating a plurality of data signals, each of which turns on or off the LED of one of the pixels in the selected row of the array, and adjusting a width of the pulse in the scan signal fed to the selected row according to the number of turned-on pixels in the selected row.

The present invention further provides an LED display comprising an array composed of rows and columns of pixels, each of which comprises an LED, a row driver generating a plurality of scan signals, each of which is fed to a corresponding row, wherein one of the rows is selected when a pulse occurs in the corresponding scan signal, and a column driver generating a plurality of data signals, each of which turns on or off the LED of one of the pixels in the selected row of the array, wherein a width of the pulse in the scan signal fed to the selected row is adjusted according to the number of turned-on pixels in the selected row.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows an LED display.

FIG. 2 is a timing diagram of a conventional LED display.

FIG. 3 is a timing diagram of an LED display according to one embodiment of the invention.

FIG. 4 is a flowchart of a method for driving an LED display according to one embodiment of the invention.

### DETAILED DESCRIPTION OF THE INVENTION

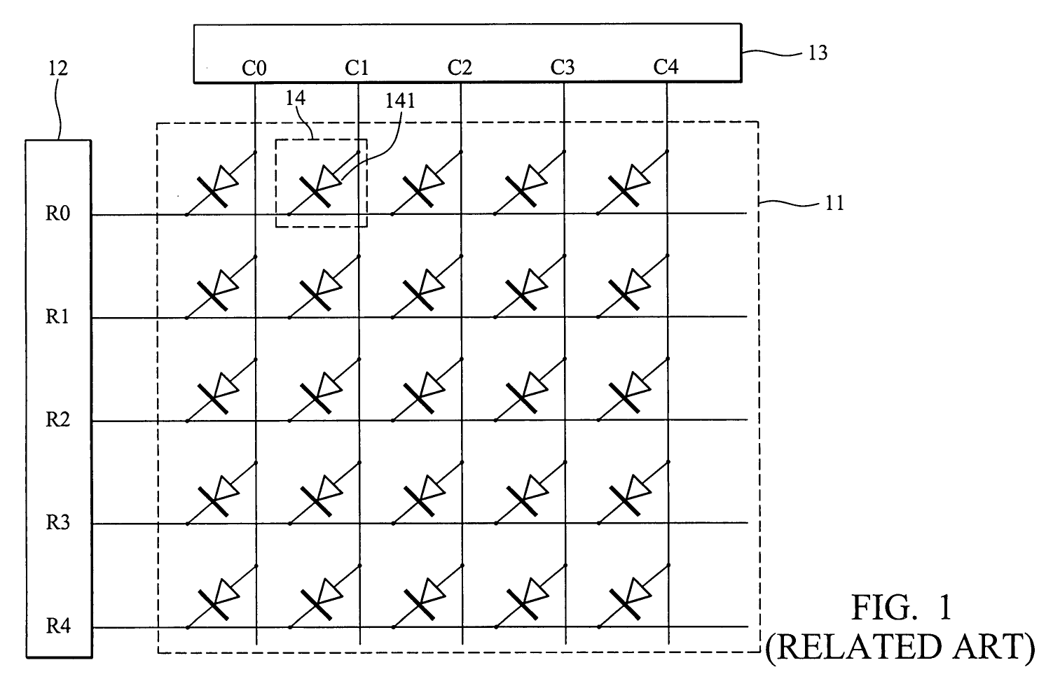

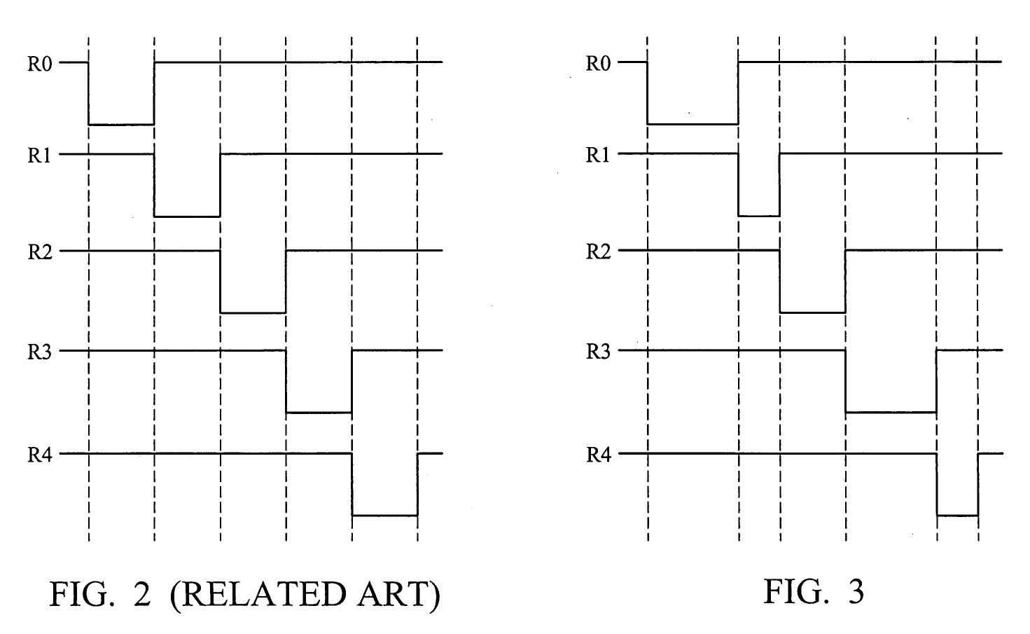

The PLED or OLED display according to one embodiment has the same circuit structure as that shown in FIG. 1 in. It includes an array 11, a row driver 12 and a column driver 13. The array 11 is composed of rows and columns of pixels 14. Each of the pixels 14 has an LED (PLED or OLED) 141 with the cathode coupled to one of the scan lines R0˜R4 and the anode coupled to one of the data lines C0˜C4. For illustration, the array 11 shown in FIG. 1 has a size of only 5*5. In practice, the size of the array 11 is typically much larger than 5*5.

The operation of the PLED or OLED display will be described in the following with reference to FIG. 3 which shows a timing diagram of the display. The row driver 12 generates a scan signal on each of the scan lines R0˜R4. There are negative pulses occurring periodically in each of the scan signals. When any of the negative pulses occurs on one of the scan lines R0˜R4, the row connected thereto is selected, wherein the voltage level on the cathodes of the LEDs 141 in the selected row is pulled down. If a relatively high voltage level is generated by the column driver 13 on the data line connected to the LEDs 141 in the selected row, these LEDs 141 are turned on. The other un-selected rows of the LEDs 141 are turned off even if the high voltage level is generated on the data lines connected thereto. This is because the voltage across the LEDs 141 are not large enough due to the voltage level on their cathodes not being pulled down by the scan signals. As the row driver 12 sequentially generates pulses on the scan lines R0˜R4, the rows of the array 11 are selected-one by one, and the column driver 13 generates the high and low voltage levels on the data lines C0˜C1 according to the data of pixels to turn on or off the LEDs 141 in the selected row, which forms frames of images.

It is noted that the widths of the pulses in the scan signals are not the same, which is different from those in a conventional PLED or OLED display. The width of each pulse generated on the scan lines to select a row is proportional to the number of the turned-on LEDs in the selected row. For example, If there are three turned-on LEDs in the row R0 and one turned-on LED in the row R1, the width of the pulse for selection of the row R1 is three times larger than that for the row R0. Although the column driver 13 drives three LEDs in the row R0 but only one LED in the row R1, the equivalent luminance of the rows R0 and R1 are the same since the LEDs in row R0 is turned on for a period three times longer than that in row R1. Thus, the non-uniformity of luminance is compensated.

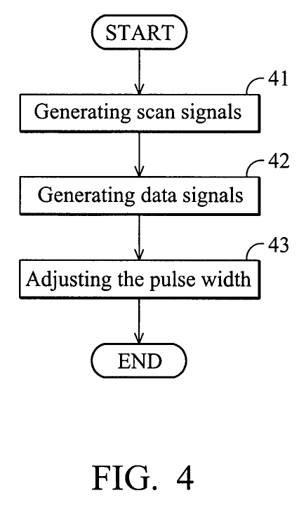

FIG. 4 is a flowchart of a method for driving an LED display according to one embodiment of the invention.

In step 41, a plurality of scan signals are generated. Each of the scan signals is fed to a corresponding row, wherein one of the rows is selected when a pulse occurs in the corresponding scan signal.

In step 42, a plurality of data signals are generated. Each of the data signals turns on or off the LED of one of the pixels in the selected row of the array.

In step 43, the width of the pulse in the scan signal fed to the selected row is adjusted proportionally to the number of turned-on pixels in the selected row.

In conclusion, the present invention provides an LED display and method for driving the same, which achieves frames of images with uniform luminance. The pulse widths of the scan signals vary with the number of turned-on pixels. The duration during which the LEDs in one selected row are turned on is proportional to the number of the turned-on LEDs. This compensates for the non-uniformity of luminance resulting from the variation of the number of turned-on LEDs.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for driving an LED display having an array composed of rows and columns of pixels, wherein each of the pixels comprises an LED, the method comprising the steps of:
generating a plurality of scan signals, each of which is fed to a corresponding row, wherein one of the rows is selected when a pulse occurs in the corresponding scan signal;
generating a plurality of data signals, each of which turns on or off the LED of one of the pixels in the selected row of the array; and
adjusting a width of the pulse in the scan signal fed to the selected row according to the number of turned-on pixels in the selected row.

2. The method as claimed in claim 1, wherein the width of the pulse in the scan signal fed to the selected row is adjusted proportional to the number of turned-on pixels in the selected row.

3. The method as claimed in claim 1, wherein the LEDs are PLEDs.

4. The method as claimed in claim 1, wherein the LEDs are OLEDs.

5. The method as claimed in claim 1, wherein the scan signals are generated by a row driver while the data signals are generated by a column driver.

6. An LED display comprising:
an array composed of rows and columns of pixels, each of which comprises an LED;
a row driver generating a plurality of scan signals, each of which is fed to a corresponding row, wherein one of the rows is selected when a pulse occurs in the corresponding scan signal; and
a column driver generating a plurality of data signals, each of which turns on or off the LED of one of the pixels in the selected row of the array;
wherein a width of the pulse in the scan signal fed to the selected row is adjusted according to the number of turned-on pixels in the selected row.

7. The LED display as claimed in claim 6, wherein the width of the pulse in the scan signal fed to the selected row is adjusted proportional to the number of turned-on pixels in the selected row.

8. The LED display as claimed in claim 6, wherein the LEDs are PLEDs.

9. The LED display as claimed in claim 6, wherein the LEDs are OLEDs.
